(19) United States
(12) Patent Application Publication
(10) Pub. No.: US 2003/0187773 A1
(43) Pub. Date: Oct. 2, 2003

(54) Virtual marketplace agent technology

(76) Inventors: Cipriano A. Santos, Modesto, CA (US); Kemal Guler, Cupertino, CA (US); Dirk Beyer, Walnut Creek, CA (US)

Correspondence Address: HEWLETT-PACKARD COMPANY, Intellectual Property Administration, P.O. Box 272400, Fort Collins, CO, 80527-2400, US

(21) Appl. No.: 10/114,598

(22) Filed: Apr. 2, 2002

(51) Int. Cl. G06F 17/60

(52) U.S. Cl. 705/37

(57) ABSTRACT

A virtual marketplace employing automated agents. Buyer agents and seller agents interface via a market-clearing agent to using a common vocabulary by which the clearing agent can negotiate matches between buyers' and sellers' offers represented respectively by the buyer agent and seller agent modeled for a transaction. Mathematical modeling and problem solver technology is employed for each of the agents such that negotiations over a bid-offer transaction can be automatically solved.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO AN APPENDIX

Not Applicable.

### BACKGROUND

1. Field of Technology

The field of technology relates generally to virtual marketplace infrastructures and methods of operating therein.

2. Description of Related Art

In the global market, the use of computers and networks for business-to-business (“B2B”) trade has made resource planning systems, also referred to as Enterprise-Resource-Planning (“ERP”) systems, important to the continued success of a business. Supply chain data and management decisions are variables that reflect explicit business objectives and constraints which must be translated into specific and appropriate buy-sell bid-offers in transactions which are now often conducted in a virtual marketplace. However, such data—e.g., requirements, bills of material, inventory, capacity, and the like—and a business' decision making processes are at the same time often considered to be highly confidential or even trade secrets of the respective businesses involved in the transactions.

In a business-to-business market where complex contracts are executed between a buyer and seller, many factors must be taken into consideration by both parties. In view of the emergence of the virtual marketplace, Enterprise-Resource-Planning systems, generally implemented in expensive, customized, computer software, for optimizing a particular business' objectives, production planning, marketing, procurement and sales, fulfillment, delivery, accounting, service strategies, and the like, have been developed and commercialized. For example, SAP (http://sap.com/solutions/) or J. D. Edwards (http://jdedwards.com) provide such systems. However, these rule-based, computerized systems, also referred to in the art as “expert systems,” focus on the internal operations of a specific business and the modeling of the behavior of each individual user, with the system software engine necessarily requiring such highly confidential and trade secret information. The Enterprise-Resource-Planning data is generally developed by an employee, e.g., a procurement agent, to develop a current, real-time, bid-to-buy, or more simply the bid, or a current, real-time, offer-to-sell, or more simply the offer, also referred to in the art as an ask. Thus, these rule-based systems are limited in their ability to optimize business objectives while still satisfying business rules and constraints for the complex contracts. In other words, a limitation is imposed by having the focus on the specific businesses themselves rather than on the actual virtual marketplace transactions themselves. U.S. Pat. No. 5,924,082 (Silverman et al.), Jul. 13, 1999, is an example of one such business matching system.

### BRIEF SUMMARY

In a basic aspect, there is described herein a method and system providing buy-and-sell mathematical programming agents for a virtual marketplace infrastructure. The exemplary embodiment system described, automates decision making. The system is based on mathematical optimization. The system implements anonymity, privacy, and security for proprietary data. The system is distributed, residing in different computer systems.

The foregoing summary is not intended to be an inclusive list of all the aspects, objects, advantages and features of described embodiments nor should any limitation on the scope of the invention be implied therefrom. This Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches.

### BRIEF DESCRIPTION OF THE DRAWINGS

FIG. 1 is a block diagram representative of an exemplary embodiment for a system and virtual marketplace transaction implementing embodiments of the present invention.

FIG. 2 is a block diagram of a buyer agent, showing interface with the operation of the system according to FIG. 1.

FIG. 3 is a block diagram of a seller agent, showing interface with the operation of the system according to FIG. 1.

FIG. 4 is a block diagram of a buyer agent, showing interface with the operation of the system according to FIG. 1.

FIG. 5 is a flow chart of operations for the system according to FIG. 1.

Like reference designations represent like features throughout the drawings. The drawings referred to in this specification should be understood as not being drawn to scale except if specifically annotated.

### DETAILED DESCRIPTION

Subtitles are used herein for the convenience of the reader. No limitation on the scope of the invention is intended nor should any be implied therefrom.

General Description

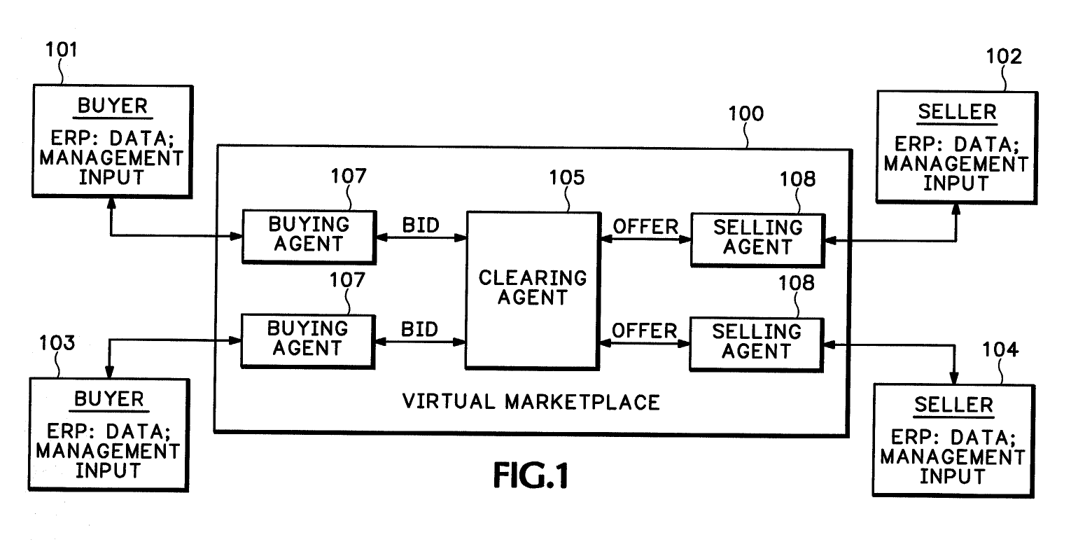

FIG. 1 is a representation of an embodiment of an automated virtual marketplace 100 where businesses, namely, buyers 101, 103 and sellers 102, 104, may conduct business-to-business transactions. Embodiments of the present invention described here will be exemplified by a buy-sell transaction for goods. It should be recognized that the system and process is equally applicable to bargaining for services, commodities, legal duties and obligations, and the like.

Mathematical modeling of a Clearing Agent 105, Buyer Agents 107 and Seller Agents 108 allows for sophisticated, automated buy-sell type operations that are substantially equal to human interaction transactions. Further, the use of programming using mathematical modeling of the agents performing the actual marketplace transactions allows the transaction principals, buyers and sellers, to detach their proprietary confidential information from a virtual marketplace transaction.

A configurable, virtual, Buyer Agent 107 is modeled by mathematical programming such that procurement costs are minimized while satisfying the sellers' technology, quality, responsiveness, delivery and environment rules, with minimum levels of performance metrics, while satisfying demand of product from the buyer's customers, and satisfying minimum-maximum volumes of product contracted for.

A configurable, virtual, Seller Agent 108 is modeled by mathematical programming and solver routines such that final assembly decisions can be made, maximizing the seller's gross profits, while satisfying the seller's customers' (buyers) demand and its supply constraints—e.g., inventory, materials, production capacity, allocation (preferred customer distribution), and the like.

A virtual marketplace Clearing Agent 105 is employed whereby buyer demand is matched with a supply at a price-fit in an anonymous manner. In this exemplary embodiment, the Clearing Agent 105 may operate in a broadcast mode, where bids and offers are distributed iteratively and automatically in accordance with the Clearing Agent mathematical programming model and solver routines as described in more detail hereinafter.

Buyer Agent 107

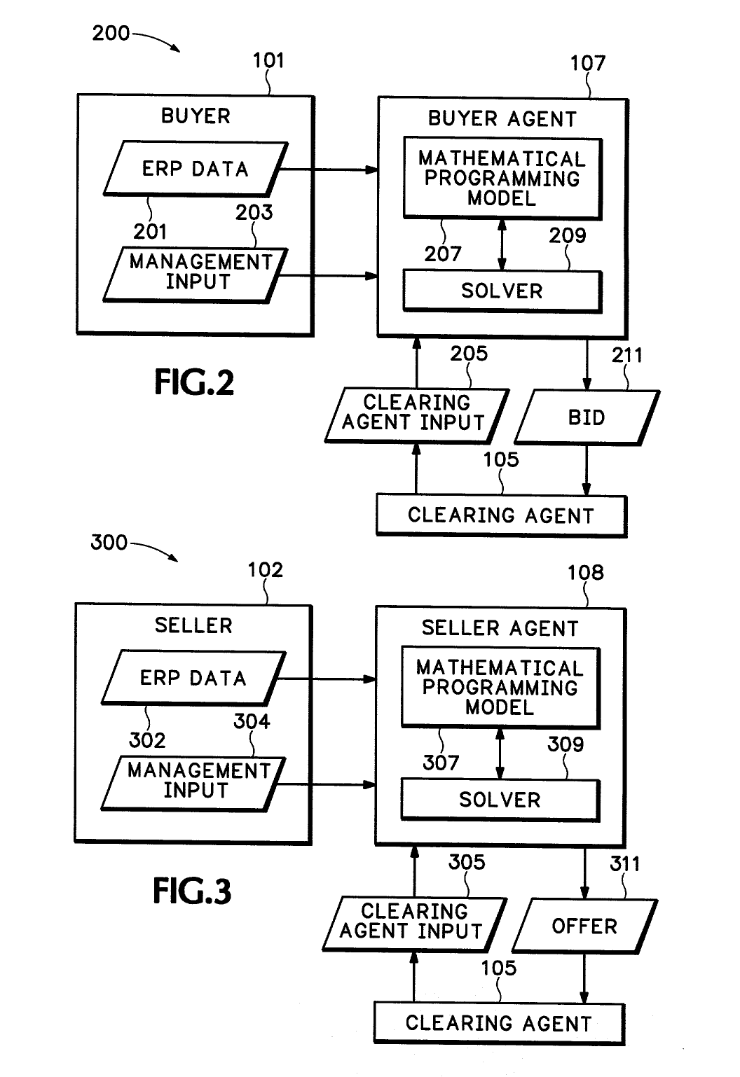

FIG. 2 is a block diagram of a mathematical programming model illustrating a tool and process flow 200 for a Buyer Agent 107. The Buyer Agent 107 is a routine that is integrated with its respective Enterprise-Resource-Planning system purchasing modules. The integration process will necessarily be dependent upon the specific implementation of the Enterprise-Resource-Planning system employed by the principal, whether a buyer or seller; other than to note that such integration is basically an interface routine to extract operations data and quantifiable management objectives data from the Enterprise-Resource-Planning system for use by the buyer and seller agent routines described herein, further discussion of such known manner software integration processes is not necessary here for a full understanding of the embodiments of the present invention.

As one exemplary embodiment, a buyer 101, 103, or a procurement analyst employee of the buyer entity, configures the Buyer Agent 107 in terms of Enterprise-Resource-Planning Data 201 and business decisions and rules, Management Input, 203, such as the nature of percentages of product requirements that can be given to sellers. One example of the decisions, objective functions, and constraints and rules to be satisfied that entails the Buyer Agent 's 107 mathematical programming model is as follows.

1. Decisions:

a. How much product to buy;

b. When to buy the product;

c. Which acceptable sellers supply the product.

In another exemplary embodiment, assume one of the sellers 102, 104 might be a spot market; the procurement analyst can configure the Buyer Agent 107 by allocating certain percent of the product requirements to the spot market.

2. Objective Function(s):

Generally, the objective function of the buyer may be to maximize gross profit defined by the revenue generated by the sales associated to the end products that use as components the products purchased from sellers, minus purchasing costs, minus penalties paid for products not bought as forecasted.

3. Business' constraints and rules to be satisfied:

a. Product requirements;

b. Percentages ranges of product requirement assigned to sellers;

c. Minimum levels of sellers' performance metrics for technology, quality, responsiveness, delivery, and environment.

Buyer's ERP Data 201

One input to the Buyer Agent 107 module of the system 200 is Enterprise-Resource-Planning data 201 which includes each buyers' 102, 103 respective confidential data. It can be either static or dynamic. For example, such data can include static data entailing bill of materials or dynamic data entailing buyer's products demand—e.g., customer orders and forecast—and products and parts inventory levels.

Buyer's Management Input 203

Another input to the Buyer Agent 107 module of the system 200 is Management Input 203 data. This is also generally the buyer 101, 103 company confidential and trade secret information as needed. Management Input 203 generally reflects quantifiable strategy and judgment of the specific buyer 101, 103, e.g., the company's procurement analyst.

In one exemplary embodiment, Management Input 203 entails budget data for procurement parts, weights for reliability of forecast—or probability product demand realized as forecasted, percentage ranges of procurement parts assigned to suppliers (sellers), and minimum levels of suppliers' (sellers) performance metrics, such as technology, quality, delivery, responsiveness and environment.

Clearing Agent Input 205 to Buyer Agent 107

A third input to the Buyer Agent 107 module is Clearing Agent Input 205 data. This also is non-confidential, public, data which entails the output (FIG. 1 arrow labeled “offer”), as described hereinafter, of marketplace 100 suppliers, viz., sellers 102, 104.

Buyer Agent Submodules 207, 209

The Buyer Agent 107 processing module includes two sub-modules 207, 209.

(0.1) Buyer Agent Mathematical Programming Model 207

In one embodiment, this module has a business objective routine based on a function that maximizes gross profit, where gross profit is generally defined as the revenue generated by the products firmed orders plus the expected revenue generated by the products forecast demand minus purchasing costs minus penalties paid to suppliers (sellers) for procurement parts not procured as agreed. The business constraints and rules to be satisfied may include:

a. Product and parts balance equations;

b. Budget limit inequalities for procured parts;

c. Inequalities to ensure that procured parts do not exceed parts availability from suppliers (sellers);

d. Inequalities to ensure that procurement parts from suppliers (sellers) are within specified percentage ranges;

e. Inequalities to ensure performance metrics minimum levels of suppliers (sellers).

This formulation represents one possibility among many others, and by no means is intended to restrict the scope or extensions of the invention, nor should any intention be implied from and such exemplary embodiment. The mathematical programming formulation might be set up as a linear programming problem, a mixed integer programming problem, or a non-linear programming problem. The mathematical programming model can be programmed using commercially available modeling tools such as the General Algebraic Modeling Systems (“GAMS”—see e.g., http://www.gams.com) or A Modeling Language for Mathematical Programming (“AMPL”—see e.g., http://www.ampl.com), among others known to those skilled in the art.

(0.2) Buyer Agent Solver 209

For linear and mixed integer programming problems there are commercially available solvers such as “ILOG/Cplex” (see e.g., http://www.ilog.com/products/cplex) or “IBM/OSL” (see e.g., http://www.optimize.com), among others known to those skilled in the art, that can be employed to solve these problems very efficiently. For non-linear programming problems there are commercially available solvers such as “MINOS” (see e.g., http://www.sbsi-sol-optimize.com) or “CONOPT” (see e.g., http://www.conopt.com), among others known to those skilled in the art, that can be employed to solve these problems very efficiently. In addition, for mixed integer programming problems and non-linear programming problems proprietary meta-heuristics, such as genetic algorithms and simulated annealing, among others known to those skilled in the art, can be developed and used as a solver.

Note that the particular solver(s) employed for a specific implementation will be dependent upon the types of rules, for both constraints and management objectives that are to be used.

Buyer Agent Output (BID) 211

The output 211 of the Buyer Agent 107 is the solution of the Mathematical Programming Model 207 that may be in the form of a table that defines,

a. how much of each procurement part to buy,

b. at which price, from which supplier,

c. at which time period.

This table constitutes the bid 211 of the Buyer Agent 107 and represents an input of the Clearing Agent 105.

Seller Agent 108

Referring to FIG. 1, the products of the sellers 102, 104 (suppliers) may be, for example, procurement parts of the buyers 101, 103 (customers). FIG. 3 is a block diagram of a mathematical programming model illustrating a tool and process flow 300 for a Seller Agent 108. The Seller Agent 108 is a routine that is integrated with the respective Enterprise-Resource-Planning system of the seller 102 that manages the products that the seller produces.

As one exemplary embodiment, the seller's 102 production planner configures the Seller Agent 108 by setting priorities for buyers' demand of products. In case of shortage, the Seller Agent is configured to allocate production to demand from potential buyers based on predetermined priorities. One example of the decisions, objective function(s), and constraints that compose the Seller Agent 108 is as follows.

1. Decisions:

a. How much to produce and how much product demand to cancel;

b. When to produce; and

c. Which buyer to satisfy product demand.

In another embodiment, assume a potential buyer is the spot market; therefore, some production might be sold in the spot market. This is an attractive option when there is excess of capacity.

2. Objective Function(s):

Generally, the objective function of this the seller may be to maximize gross profit defined by the revenue generated by the sales of the products manufactured minus manufacturing costs minus penalties paid for not satisfying demand of products required by buyers.

3. The business constraints and rules to be satisfied:

a. Capacity limits;

b. Raw material availability limits; and

c. Buyers product demand priorities.

Seller's ERP Data 302

A first input to the Seller Agent 108 routine is the Seller 102 Enterprise-Resource-Planning Data 302. This is generally confidential data or trade secrets of the Seller 102. It can be static or dynamic. In one exemplary embodiment, such data 302 includes:

a. Static data entails bill of materials and production capacity limits; and

b. Dynamic data entails products demand (orders and forecast), and products and parts inventory levels.

Seller's Management Input 304

A second input to the Seller Agent 108 module 108 is Management Input 304 information; that also is generally confidential or trade secret information. It reflects strategy and judgment of production planners.

In one exemplary embodiment, Management Input 304 is data that entails budget for manufacturing, weights for reliability of forecast or probability product demand realizes as forecasted, and priority of customer (buyer) demand.

Clearing Agent Input 305 to Seller Agent 108

A third input to the Seller Agent 108 is from the Clearing Agent 105. Clearing Agent Input 305 to the Seller Agent 108 is data that has public and private components, including the output (bid) 211 of seller's 102, 104 customers (buyers 101, 103). The content of the information exchanged follows a protocol agreed upon by all participants in the on-line marketplace.

Seller Agent 108 Submodules 307, 309

The Seller Agent 108 is a processing module that entails two sub-modules.

(0.1) Seller Agent Mathematical Programming Model 307

In one exemplary embodiment, this module 307 may have a business objective function that maximizes gross profit defined as the revenue generated by the products firmed orders plus the expected revenue generated by the products forecast demand minus manufacturing costs minus penalties paid to customers (buyers) for products not sold as agreed. Depending on the specific implementation, the business constraints and rules to be satisfied include, but, are not limited to:

a. Product and parts balance equations;

b. Inequalities to ensure capacity limits are satisfied;

c. Budget limit inequalities for manufacturing costs; and

d. Satisfy customer (buyer) demand by priority.

Again, this formulation represents one possibility among many others, and by no means restricts the scope and extensions of the invention. The mathematical programming formulation might be a linear programming problem, a mixed integer programming problem, or a non-linear programming problem. The mathematical programming model can be programmed using commercially available modeling tools such as GAMS or AMPL, among others known to those skilled in the art.

(0.2) Seller Agent Solver 309

For linear and mixed integer programming problems there are commercially available solvers such as ILOG/Cplex or IBM/OSL, among others known to those skilled in the art that can be employed to solve these problems very efficiently. For non-linear programming problems there are commercially available solvers such as MINOS or CONOPT, among others known to those skilled in the art that can be employed to solve these problems very efficiently. In addition, for mixed integer programming problems and non-linear programming problems in-house meta-heuristics such as genetic algorithms and simulated annealing, among others, can be developed and used as solver.

The output 311 of the Seller Agent 108 is the solution of the mathematical programming model that may be in the form of a table that defines, e.g.,

a. how much of each product to manufacture,

b. at which price, for which customer (buyer),

c. at which time period, and

d. canceled orders.

This table constitutes the offer 311 of the Seller Agent 108 and represents an input to the Clearing Agent 105.

Clearing Agent 105

The Clearing Agent 105 may employ traditional market clearance procedures, where demand is matched with supply at a price. Known manner market clearing procedures are, for example, call markets with periodic clearing or continuous clearing rules such as those followed by the New York Stock Exchange (NYSE®).

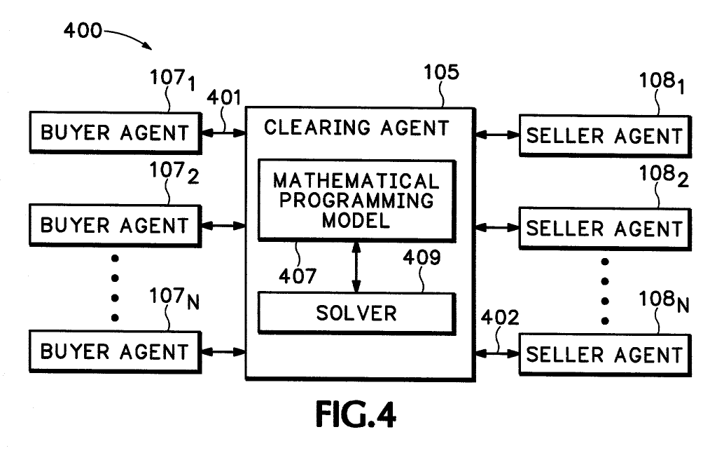

As shown in FIG. 4, a block diagram of a mathematical programming model illustrating a tool and process flow for a Clearing Agent 105 in accordance with an embodiment of the present invention, the Clearing Agent exercises the actions that the Buyer Agents 107₁, 107₂ . . . 107_{N} and Seller Agents 108₁, 108₂ . . . 108_{M} requested. The Buyer Agents 107_{1-N} post bid objects 401, represented as arrows and described in more detail hereinafter. The Seller Agents 108_{1-M} post offer objects 402, also represented as arrows and described in more detail hereinafter.

In one embodiment, the Clearing Agent clears the market as follows.

(0.1) Seller and Buyer Agents are kept anonymous.

(0.2) Clearing Agent takes posted asks and allocates buyers bids with suitable sellers asks.

(0.3) Allocations can be done continuously or at discrete time periods.

In another embodiment, the Clearing Agent qualifies sellers and buyers and clears the market as follows.

(0.1) Seller and buyers agents are not anonymous.

(0.2) Clearing Agent takes posted bids and seller and buyers qualifications, and allocates buyers' bids with suitable sellers' asks. Qualifications entail quality of product, technology of product, buyer and seller ratings in business-to-business marketplace, in general, it may be any metric that qualifies the buyer, the seller, and the product exchanged in the marketplace.

Inputs from Buyer Agents 107

The Clearing Agent 105 receives a bid object from each Buyer Agent. A bid object consists of

(0.1) A unique identification code to identify the principal represented by the Buyer Agent.

(0.2) A list of items, also referred to in the art as trade goods, where each item is a product specification stated in a vocabulary shared by all system participants, the buyers, the sellers and the market operator.

(0.3) A list of eligible suppliers for each item in the item list, where this list describes the qualified suppliers of the item. This list may be stated in variety of ways as described by the following examples.

(0.3.1) Explicit enumeration of supplier names or supplier identification codes. For example, <ABC, Inc., XYZ Ltd., etc.>

(0.3.2) Rule-based description of qualified sellers. For example, <any seller such that (i) it is located in California, USA, (ii) it has production capacity no less than 1,000,000 units/per month, (iii) it has a market capitalization that is no less than $ 10b, etc.>

(0.3.3) Alternatively, explicit enumeration and descriptive rules may be combined to state the eligible suppliers.

(0.4) A range of dates for each item in the item list representing the acceptable delivery dates for the item.

Inputs from Seller Agents 108

The Clearing Agent 105 receives an offer object 402 from each Seller Agent 108_{1-M}. An offer object 402 is representative generally of information such as

(0.1) product quantity and price,

(0.2) a list of acceptable product quantities and associated prices, or

(0.3) a demand curve.

An offer object 402 may include the following.

(0.4) A unique identification code to identify the principal represented by the Seller Agent 108.

(0.5) A list of items. Each item is a product specification stated in a vocabulary shared by all system participants, the buyers, the sellers and the market operator.

(0.6) A list of eligible buyers for each item in the item list. This list describes the qualified buyers of the item. This list may be stated in variety of ways.

(0.6.1) Explicit enumeration of buyer names or buyer identification codes. For example, <ABC, Inc., XYZ Ltd., etc.>

(0.6.2) Rule-based description of qualified buyers. For example, <any buyer such that (i) it is located in California, USA, (ii) it has a market capitalization that is no less than $ 10b, etc.>

(0.6.3) Alternatively, explicit enumeration and descriptive rules may be combined to state the eligible buyers.

(0.7) A range of dates for each item in the item list representing the acceptable delivery dates for the item.

Clearing Agent 105 Submodules 407, 409

The Clearing Agent 105 is a processing module that entails two sub-modules 407, 409.

(0.1) Clearing Agent Mathematical Programming Model 407

In one embodiment, this module has a system objective function that maximizes total surplus, defined as the sum of the buyers' surplus and the sellers' surplus. These concepts are standard concepts in microeconomics. The buyers' surplus is the area between the market demand schedule and the horizontal line that corresponds to the price level. Similarly, the sellers' surplus is the area between the market supply schedule and the price line. In an alternative embodiment, the objective function of the mathematical programming model for the Clearing Agent 105 is of excess demand and the objective is to minimize excess demand by selecting prices. Excess demand is also standard microeconomics concept that represents the difference between quantity demanded and quantity supplied at various price levels. A market-clearing price is the price that makes excess demand zero. This formulation represents one possibility among many others, and by no means restricts the extensions of the invention. The mathematical programming formulation might be a linear programming problem, a mixed integer-programming problem, or a non-linear programming problem. The mathematical programming model can be programmed using commercially available modeling tools such as GAMS or AMPL, among others.

(0.2) Clearing Agent Solver 409.

For linear and mixed integer programming problems there are commercially available solvers such as ILOG/Cplex or IBM/OSL, among others, that can solve these problems very efficiently. For non-linear programming problems there are commercially available solvers such as MINOS or CONOPT, among others, that can solve these problems very efficiently. In addition, for mixed integer programming problems and non-linear programming problems, in-house meta-heuristics such as genetic algorithms and simulated annealing, among others, can be developed and used as solver.

Clearing Agent Determination of Trades and Prices

The market for each item consists of buyers 101, 103 and sellers 102, 104 who respectively have submitted bids and offers for the item and whose bids and offers may be compatible. Compatibility is determined by matching the acceptable delivery dates stated in the bids and offers. Thus, as in standard economic modeling, a single item with two different delivery dates is considered as two different trade goods for the purpose of determining trades and prices.

The Clearing Agent 105 may operate in a variety of ways. Two standard market-clearing rules commonly used in many markets are continuous clearing and periodic clearing. Under continuous clearing, bids and offers are processed as they are submitted and are matched continuously, in the sense that as soon as a bid arrives with an amount that is greater than the current best offer price, it is matched immediately with that current best offer and a transaction occurs at a price determined by the bid and offer. Under periodic clearing, bids and offers are collected during a pre-specified time period and the matching is performed at the end of the period. Under this rule, all transactions that take place, take place at a single price. This price is determined as a function of all bids and offers submitted. The bids submitted are sorted in descending order to obtain a market demand schedule. Similarly, the offers submitted are sorted in ascending order to form a market supply schedule. The price that corresponds to the intersection of the market demand and the market supply schedules is market-clearing price.

Each market-clearing rule has a number of variants determined by the information disclosure rules of the Clearing Agent 105. For example, under a continuous clearing rule system, the Buyer Agents 107 and Seller Agents 108 may be allowed to see past transaction prices as well as the current best bids and offers. Similarly, under the periodic clearing rule, the participants may or may not be allowed to observe the submitted bid and offer prices.

### Exemplary Marketplace Operations

A particular exemplary embodiment of the operations of the Clearing Agent 105 under the periodic clearing rule is now described. In this embodiment, the Buyer Agents 107 and Seller Agents 108 are informed about the current market-clearing price at every point in time before pre-announced final clearing time. Current market-clearing price at time is determined by the intersection of demand and supply schedules constructed from bids and offers submitted before time “t.” If the demand and supply schedules so constructed do not intersect, then a pseudo-price (denoted, e.g., by “#”) is announced.

The market “x01012002” opens as soon as a Buyer Agent 107 submits a bid object or a Seller Agent 108 submits an offer object with item “X” and a delivery date of Jan. 1, 2002 and closes, e.g., a week after it opens. Initially, the market-clearing price is “#.” As the Buyer Agents 107 and Seller Agents 108 submit bids and offers, the market-clearing price is updated and announced as a current market-clearing price “#_{c}” to the market participants. At the closing time, the final market-clearing price “#_{f}” as well as the Buyer Agents 107 agents with bid prices that exceed this price and the Seller Agents 108 with offer prices that are no greater than the final market-clearing price trade quantities that they submitted. Note that since there may be a time limit, at closing time the quantities for bids and offers might not perfectly match.

In an alternative exemplary embodiment, the Buyer Agents 107 and Seller Agents 108 submit demand and supply schedules, respectively. A demand schedule submitted by a Buyer Agentᵢ, “i, dᵢ (p),” specifies the quantity demanded at various price levels. Similarly, a supply schedule submitted by a Seller Agentⱼ, “j, sⱼ (p),” specifies the quantity that Seller Agentⱼ is willing to sell at various price levels. The Clearing Agent 105 adds the quantities demanded at each price to obtain the market demand schedule. Similarly, the market supply schedule is obtained by adding the quantities various sellers are willing to sell at various prices. Denoting the market demand function by “D (p),” and the market supply function by “S(p),” the excess demand function is the difference:

E(p)=D(p)−S(p) (Equation 1).

The Clearing Agent 105 solves Equation 1 for the price that minimizes “E(p).” If the price that solves the Clearing Agent 105's minimization problem is “p*,” then Buyer Agentᵢ buys “dᵢ (p*)” units of the trade goods, and Seller Agentⱼsells “sⱼ(p*)” units of the same trade goods.

A Generalized Example for a Method of Doing Business in a Virtual Marketplace

The following eleven assumptions are exemplary transaction characteristics.

1. The products, trade goods, exchanged in this market place have a high degree of added valued, such as high tech components (e.g., integrated circuits such as CPU, DRAM, SRAM, or elaborated chemicals).

2. The products exchanged in this market place are managed by Enterprise-Resource-Planning systems at the sellers and buyers respective enterprises.

3. Sellers may be the suppliers of buyers and buyers may be the customers of the sellers.

4. Sellers have their own suppliers and buyers have their own customers.

5. Sellers and buyers gather data from their Enterprise-Resource-Planning systems.

6. Enterprise-Resource-Planning data includes bill of materials, resources capacity, inventory availability, demand forecast, suppliers and customers profiles, and the like as known to those practicing in the state of the art.

7. Sellers and buyers input management information to their respective seller or Buyer Agent.

8. The input management information entails budgets, priorities for demand and supply sources, criteria to qualify products, and the like as known to those practicing in the state of the art.

9. The Seller and Buyer Agents translate management inputs and Enterprise-Resource-Planning data into bids for the marketplace.

10. The Clearing Agent clears the market by allocating buyers bids to suitable seller offers.

11. Suitability of bids and offers are specified in terms of the management inputs from sellers and buyers.

Thus, the Buying Agent 107 and the Selling Agent 108 each permit three kinds of input:

(1) from Enterprise-Resource-Planning system,

(2) from a procurement analyst or a production planner, and

(3) from the Clearing Agent 105.

The first two sets of input (1), (2) are used to configure the respective agent by formulating some parameterized mathematical programming problem, “P(x),” where “x” is a particular value of the message that may be received from the market (3); i.e., potential messages, information, from the Clearing Agent 105 are parameters.

A simple scenario is where the Buying Agent 107 is configured to decide how many units of a “widget W,” to buy as a function of the current market prices and widget W availability. Thus, the Buying Agent 107

(1) receives the current value of the price and quantity available parameters, e.g. “x0,” from the Clearing Agent 105,

(2) the Buyer Solver 109 solves its decision problem, “P(x0),” for the particular instance X=x0,

(3) sends the optimal decision, e.g. “q(x0),” to the Clearing Agent 105, and (4) waits for the next message from the Clearing Agent 105.

The Clearing Agent 105 then,

(1) performs its operations based on its knowledge of offers from Selling Agents 108_{M}, and

(2) sends a new message, e.g. “x1.”

The Buying Agent 107 then,

(1) repeats the previous operation steps by now solving a decision problem “P(x1),”

(2) sends the new optimal decision, “q(x1)” and

so on, until special message is generated from the Clearing Agent 105, e.g. <“market closed,” “final market-clearing price*,” “buyer quantity*”, “from-this-supplier*,” “on-this-date*”>,

is received. Then the Buying Agent 107 passes the necessary information back to appropriate entity employees, e.g., a procurement specialist.

The Selling Agent 108—Clearing Agent 105 interaction follows an analogous process.

As an option, if for some reason the model of an agent becomes unfeasible, then the respective agent routine should post a suitable warning to the user, e.g., “System Has Become Unstable.” SYSTEM AND PROCESS FLOW

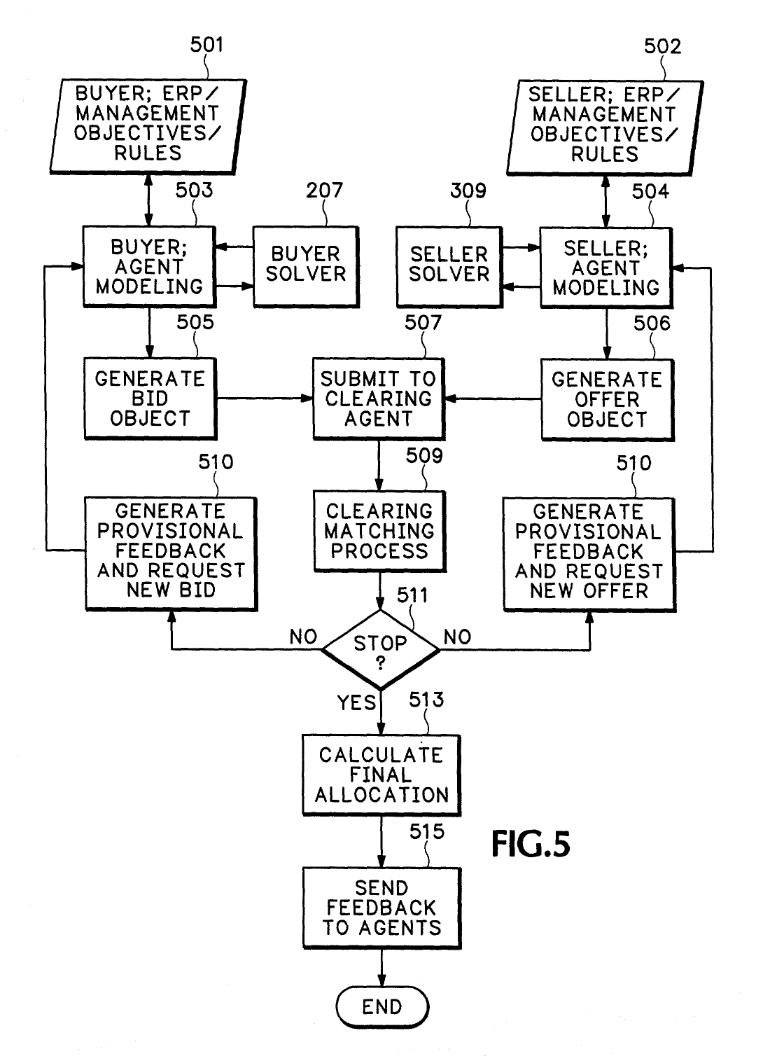

FIG. 5 is a flow chart for negotiations between a representative buyer and representative seller in the virtual marketplace embodiment of FIG. 1. The buyer inputs its ERP data, management objective data, and negotiation rules, step 501, such that modeling of an agent Buyerᵢ for the specific negotiation can be executed, step 503, creating a current transaction Buyer Agents. Similarly, the seller inputs its ERP data, management objective data, and negotiation rules, step 502, such that modeling of an agent Sellerⱼ for the specific negotiation can be executed, step 504, creating a current transaction Seller Agentⱼ.

The Buyer Agent generates an opening bid object, step 505. The Seller Agent generates an opening offer object, step 506. The opening bid object and opening offer object are submitted to the Clearing Agent 105 (FIG. 1), step 507. The Clearing Agent 105 operates on the current, viz., opening, bid and offer, step 509. If a stopping condition is not satisfied, step 511, NO-paths, the Buyer Agentᵢ and Seller Agentⱼ are notified to submit new bids and offers, steps 510. Each agent can then work with the solution from the Clearing Agent 105, using there respective Solver routines 209, 309 to reformulate a new bid object and offer object, respectively. If a stopping condition is satisfied, step 511, YES-path, the Clearing Agent 105 calculates a final allocation, step 513. Each of the affected agents is sent feedback representative of the final allocation, step 515. The process continues until the market clears or the market session is otherwise closed (END) as described hereinbefore with respect to the Clearing Agent 105 functions

It will be recognized by those skilled in the art that a variety of commercially available software tools may be employed for developing the automated virtual marketplace and agents. Note that at any given time, an entity linked to the virtual marketplace may be a buyer or a seller; therefore, the program tools provided at each entity account for the specific position in time that the entity is taking.

The foregoing description of embodiments has been presented for purposes of illustration and description. It is not intended to be exhaustive or to limit the invention to the precise form or to exemplary embodiment(s) and implementation(s) disclosed. Obviously, many modifications and variations will be apparent to practitioners skilled in this art. Similarly, any process steps described might be interchangeable with other steps in order to achieve the same result. At least one embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ” and no process step herein is to be construed under those provisions unless the step or steps are expressly recited using the phrase “comprising the step(s) of . . . ”

What is claimed is:

1. A system for automating virtual marketplace transactions, comprising:
buyer-associated programmable buy-routines based upon mathematical optimization problem solving for submitting bids-to-buy to said virtual marketplace;
seller-associated programmable sell-routines based upon mathematical optimization problem solving for submitting offers-to-sell to said virtual marketplace; and
interconnecting said buy-routines and said sell-routines, programmable clearing-agent routines based upon mathematical optimization problem solving for receiving said bids-to-buy and said offers-to-sell, respectively, for matching bids-to-buy and offers-to-sell in said virtual marketplace, and for communicating results of said matching to respective buy-routines and sell-routines.

2. The system as set forth in claim 1 wherein said buy-routines, said sell-routines, and said clearing-agent routines share a common interface vocabulary associated with said virtual marketplace transactions.

3. The system as set forth in claim 1 wherein bids-to-buy anonymity and offers-to-sell anonymity is maintained via said clearing-agent routines.

4. The system as set forth in claim 1, said buyer-associated programmable buy-routines comprising:
a buyer-agent routine for receiving buyer-associated Enterprise-Resource-Planning data and data representative of quantifiable management objectives associated with said virtual marketplace and for providing an output data set representative of a model for transactions associated with buying in said virtual marketplace.

5. The system as set forth in claim 4 further comprising:
a buyer-agent mathematical problem solver routine for receiving said output data set representative of a model for transactions associated with buying in said virtual marketplace and an output data set from said clearing-agent routines, said an output data set representative of current said offers-to-sell information from said clearing-agent routines, such that said solver routine is adapted for revising said output data set representative of a model for transactions associated with buying in said virtual marketplace therefrom.

6. The system as set forth in claim 1, said seller-associated programmable routines comprising:
a seller-agent routine for receiving seller-associated Enterprise-Resource-Planning data and data representative of quantifiable management objectives associated with selling in said virtual marketplace transactions and for providing an output data set representative of a model for transactions associated with selling in said virtual marketplace.

7. The system as set forth in claim 6 further comprising:
a seller-agent mathematical problem solver routine for receiving said output data set associated with selling in said virtual marketplace and an output data set from said clearing-agent routine, said second output data set representative of current said bids-to-buy information from said clearing-agent routines, such that said solver routine is adapted for revising said output data set associated with selling in said virtual marketplace therefrom.

8. The system as set forth in claim 1, said clearing-agent programmable routines further comprising:
a clearing-agent routine for receiving a plurality of said offers-to-sell and a plurality of said bids-to-buy and for providing an output data set representative of matches between said offers-to-sell and said bids-to-buy.

9. The system as set forth in claim 8 further comprising:
a clearing-agent mathematical problem solver routine for providing data indicative of market clearing transaction structures for each of said offers-to-sell and bids-to-buy.

10. The system as set forth in claim 1, said bids-to-buy comprising:
programmable bid-objects including unique identification code for identifying a principal represented by buy-routines, code for identifying sale items, code for listing eligible suppliers, and code specifying acceptable delivery dates.

11. The system as set forth in claim 10, said code for listing eligible suppliers comprising:
an explicit enumeration of supplier names or supplier identification codes.

12. The system as set forth in claim 10, said code for listing eligible suppliers comprising:
a rule-based description of qualified suppliers.

13. The system as set forth in claim 10, said code for listing eligible suppliers comprising:
a combination of explicit enumeration of supplier names or supplier identification codes and descriptive rules for determining qualified suppliers.

14. The system as set forth in claim 1, said offers-to-sell comprising:
programmable offer-objects including unique identification code for identifying a principal represented by sell-routines, code for identifying sale items including quantity and price, code for listing potential known buyers, and code specifying acceptable delivery dates.

15. The system as set forth in claim 14, said offers-to-sell further comprising:
a demand curve, a list of eligible buyers for each item in the item list, and a range of dates for each item in the item list representing the acceptable delivery dates for the item.

16. The system as set forth in claim 15, said list of eligible buyers further comprising:
enumeration of buyer names or buyer identification codes.

17. The system as set forth in claim 15, said list of eligible buyers further comprising:
rule-based description of qualified buyers.

18. The system as set forth in claim 15, said list of eligible buyers further comprising:
explicit enumeration and descriptive rules combined for stating the eligible buyers.

19. The system as set forth in claim 8, said programmable clearing-agent routines further comprising:
a mathematical model clearing agent wherein said output data set representative of matches between said offers-to-sell and said bids-to-buy is a function of maximized total surplus.

20. The system as set forth in claim 8, said programmable clearing-agent routines further comprising:
a mathematical model clearing agent wherein said output data set representative of matches between said offers-to-sell and said bids-to-buy is a function of minimized excess demand.

21. A method of conducting business, the method comprising:
providing computerized links to a virtual marketplace site, said site including an automated clearing agent for mathematical modeling of market clearing functions and for mathematical problem solving routines associated with said market clearing functions;
providing entities linked to the virtual marketplace site with automated buy-sell agent functionality based on mathematical modeling and mathematical problem solving routines associated with developing automated buying agents for creating bid-to-buy objects and automated selling agents for creating offer-to-sell objects wherein said objects are transmitted via said links to said clearing agent and wherein said clearing agent automatically executes said market clearing function therefrom.

22. The method set forth in claim 21 wherein said automated clearing agent is providing feedback to said agents with respect to current bid-to-buy objects and current offer-to-sell objects such that said objects may be respectively modified for facilitating bid-offer matching.

23. The method as set forth in claim 21 wherein said buying agents and selling agents are programmed for maintaining anonymity of each of their respective said entities.

24. A computerized process for business negotiation in a virtual marketplace, the process comprising:
establishing a virtual marketplace site having a virtual clearing agent residing therein;
submitting anonymous bids to said site via a mathematically modeled virtual buying agents; and
submitting anonymous asks to said site via a mathematically modeled virtual selling agents, wherein said virtual clearing agent is mathematically modeled for market clearing functionality and has mathematically modeled problem solving functionality for matching said bids to said asks.

25. The process as set forth in claim 24, comprising providing real-time feedback from said clearing agent to buying agents and selling agents negotiating for compatible virtual marketplace commodities or services such that said agents may modify said bids and said asks in response thereto.

26. The process as set forth in claim 24 comprising:
limiting access to buyer enterprise bidding information to said buying agents only and limiting access to seller enterprise selling information to said selling agents only.

27. An executable virtual marketplace model comprising:
a clearing agent wherein said clearing agent is a mathematical model for optimizing market clearing functions;
linked to said clearing agent, a plurality of buying agents wherein each buying agent is a mathematical model using respective buyer mathematical optimization models for formulating bid objects for submitting to said clearing agent; and
linked to said clearing agent, a plurality of selling agents wherein each selling agent is a mathematical model using respective seller mathematical optimization models for formulating ask objects for submitting to said clearing agent.

28. The model as set forth in claim 27, said clearing agent further comprising:
a mathematical market clearing problem solver for comparing the bid objects and the ask objects and formulating market clearing solutions therefrom.

29. The model as set forth in claim 28, each said buying agent further comprising:
a mathematical transactional-bidding problem solver for receiving said market clearing solutions from said clearing agent and reformulating bid objects therefrom.

30. The model as set forth in claim 28, each said selling agent further comprising:
a mathematical transactional-asking problem solver for receiving said market clearing solutions from said clearing agent and reformulating ask objects therefrom.

31. The model as set forth in claim 27 wherein buyer mathematical optimization model access is limited to a bidding agent level of the model and seller mathematical optimization models access is limited to a selling agent level of the model.

32. A memory device comprising:
computer code for establishing a virtual marketplace site having a virtual clearing agent residing therein;
computer code for submitting anonymous bids to said site via a mathematically modeled virtual buying agents; and
computer code for submitting anonymous asks to said site via a mathematically modeled virtual selling agent,
wherein said virtual clearing agent is mathematically modeled for market clearing functionality and has mathematically modeled problem solving functionality for matching said bids to said asks.
